(19) United States
(12) Patent Application Publication
(10) Pub. No.: US 2008/0062129 A1
(43) Pub. Date: Mar. 13, 2008

(54) Remote Controller Having Concentric Cursor Control Islands

(75) Inventors: Noel Lee, Las Vegas, NV (US); Kendrew Lee, Fremont, CA (US); Demian Martin, San Leandro, CA (US)

Correspondence Address: LARIVIERE, GRUBMAN & PAYNE, LLP, 19 UPPER RAGSDALE DRIVE, SUITE 200, MONTEREY, CA, 93940, US

(73) Assignee: Monster, LLC, Las Vegas, NV (US)

(21) Appl. No.: 11/531,270

(22) Filed: Sep. 12, 2006

(51) Int. Cl. G06F 3/033

(52) U.S. Cl. 345/161; 345/168

(57) ABSTRACT

A remote control select button 101 for use with consumer electronics and computer devices having a housing 102 for electronic circuitry for controlling remote electronic devices.

### TECHNICAL FIELD

The present invention generally relates to electronic device control. More particularly, the present invention relates to an integrated control device system for electronic device control. Yet more particularly, the present invention relates to a control component of an integrated control device for interacting with a central audio-video receiver, related peripheral device or computer.

### BACKGROUND ART

A wide variety of control devices have been proposed for use with audio/video receivers, peripheral equipment and flat screen video displays such as plasma displays and liquid crystal displays (LCD). A number of controls have also been designed for use with video projectors for use with front projection flat screens. A problem with all of such controls to date is the difficulty of use of central control devices to control remote components. There is a long-standing need for a control system which is suitable for the typical user by being easy and comfortable to use.

### DISCLOSURE OF THE INVENTION

The present invention addresses the current needs for an improved system to control consumer electronics devices. Variants of the claimed invention include a joystick element capable of freedom of movement in one, two or three dimensions by which corresponding remote control functionality can be undertaken or displayed on a corresponding display device. A variety of remote devices may be controlled by the control device to undertake different applications.

Prior art attempts to bundle multiple device remote control functionality into a single device often result in enhanced rather than reduced consumer confusion. Such devices implement user-unfriendly and cumbersome multiple menu layers accessed through ‘key chording’ requiring the user to adapt to the unfriendly user interface to undertake simple tasks.

The present invention satisfies the needs discussed above through the incorporation of a multi-axis control button capable of transmitting signals for button activation in a 360 degree range of motion based on button tilt, as well as additional function selection based on button depression.

The dual input of both button direction and button depression allow for the desired function to be selected by button inclination coupled with button depression. The corresponding function can be determined through remote control device programming, as well as through preprogrammed command functionality. By way of example and not of limitation, the joystick can be angled or bent in a particular orientation by the user's thumb. When the desired function is depicted on the remote control display, the respective function can then be undertaken by downward depression on the joystick selector button. Upon key press, the remote then broadcasts the corresponding control code (by way of IR, RF or other control signal) to the corresponding remote device to be operated.

The control joystick is also designed to work in conjunction with the surrounding ‘stadium keypad.’ Through cooperation, the functional symbol depicted on the keypad stadium such as ‘play’, ‘stop’ or ‘record’ can be undertaken through bending the joystick in the direction of the keypad then depression on the joystick selector. One additional variant is specifically designed for ease of use for the sight impaired by making the functional elements represented on the stadium keypad also contain corresponding Braille symbology. To facilitate joystick use, the corresponding remote control external shell incorporates ergonomic ‘thumb’ driven control while curved to improve prolonged hand grasping of remote device without user fatigue.

With greater particularity, the control joystick interacts with the surrounding stadium keypad to form what is called a ‘cursor control island.’ The cursor control island is the joystick, or alternately, collection of buttons that controls a cursor displayed on the display. The collection of buttons include up, down, left, right and select which are either controlled by joystick or by buttons surrounding display. Surrounding the cursor control is an external ring of additional keys making up the ‘stadium keypad.’ Ideally, both can be controlled by the user's thumb so that two distinct functional groups can be undertaken by the user.

An illustration of the above control system involves the cursor island controlling cursor control function number one. Cursor control function number one uses the cursor island to move a displayed cursor around the screen using up, down, right, left and select functions. In this particular illustration, the select function is implemented when the joystick is depressed by the user's thumb. When the select command is activated, the remote control transmits whatever function the cursor has highlighted on the display. In this illustrated, the cursor can select a particular television channel from a displayed list. In conjunction with cursor control function one, the user can then select cursor control function two. Cursor control function 2 controls device functionality, either mechanical functionality such as activating a cd transport to begin cd play or virtual device functionality such as activating a digital video player to begin playback of stored video.

Benefits of the control layout when the two sets of functions are concentric with each other include the attribute that the user doesn't have to move his or her thumb to change between function set one and function set two. While detailed in a button and joystick based embodiment, similar functionality is attained when two rings of buttons replace the joystick and button combination. Depending on control characteristics, keyboard (and joystick) backlighting is also optionally employed. In each case, the same result is achieved. For example, the joystick or center keypad is used to control an on-screen navigation icon for selection of a video program stored in a digital video recorder such as a Tivo device. Once the program is selected by using the joystick or alternately the central keypad, the user then controls digital video playback by moving his or her thumb to the outer ‘keypad stadium’ control keys. The outer keypad stadium control keys in this example are configured to control video playback fast forward by pressing the second upper right button, then the user pauses video with the upper left button, followed by resume play of the program with the first upper right then stopping playback with the second lower left button when viewing is done.

### BRIEF DESCRIPTION OF THE DRAWING(S)

For a better understanding of the present invention, reference is made to the below referenced accompanying Drawing(s). Reference numbers refer to the same or equivalent parts of the present invention throughout the several figures of the Drawing(s).

FIG. 1 is a front view of the remote control device incorporating joystick select button.

FIG. 2 is a back view of the remote control device incorporating joystick select button.

FIG. 3 is a left side view of the remote control device incorporating joystick select button.

FIG. 4 is a perspective view of the remote control device incorporating joystick select button.

FIG. 5 is a front view of the computer keyboard device incorporating joystick select button.

FIG. 6 is a front view of the computer keyboard device illustrating an additional embodiment of the housing.

FIG. 7 is a front view of the computer keyboard device illustrating the additional embodiment of the housing as set out in FIG. 6.

### MODES FOR CARRYING OUT THE INVENTION

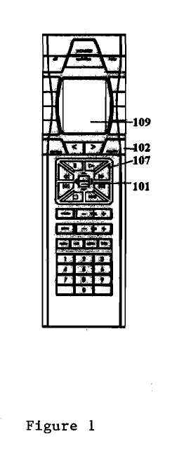

FIG. 1 is a front view of the remote control device incorporating joystick select button. In this view, joystick button 101 can be seen in conjunction with stadium keypad 107 encased by housing 102 which also frames display 109. Joystick button 101 operates both as a joystick with 360 degree motion directed towards the plane of the keypad, joystick button 101 also functions as a button when sufficient force is directed downwards on the surface of joystick button 101. While joystick button 101 is depicted in housing 102, alternate foreseen embodiments incorporate joystick button 101 in computer keyboard devices either in conjunction with stadium keypad 107 or alone. When joystick button 101 is bent towards the keypad plane, corresponding remote control functionality is displayed on display 109. When the appropriate functionality is highlighted on display 109, the desired functionality can then be activated by downward depression of joystick button 101. For physically impaired users, cooperation can be undertaken between joystick button 101 and the functions depicted on stadium keypad 107.

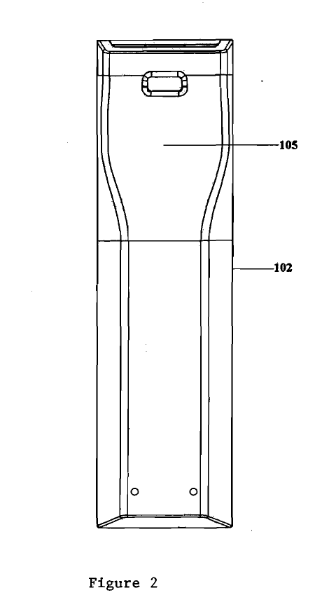

FIG. 2 is a back view of the remote control device incorporating joystick select button. Housing 102 covers internal electronics (not shown) for remote device operation and contains an indentation 105 for the index finger of the user to increase user comfort and device ergonomics.

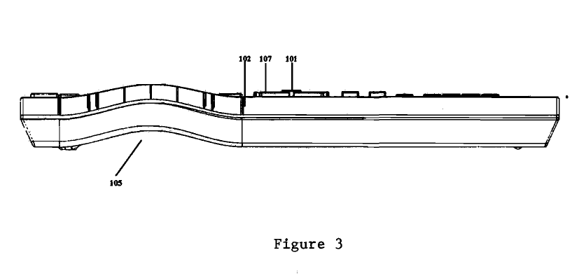

FIG. 3 is a left side view of the remote control device incorporating joystick select button. Housing 102 for button 101 and keyboard stadium 107 additionally contains an indentation 105 for the index finger of the user to increase user comfort and device ergonomics.

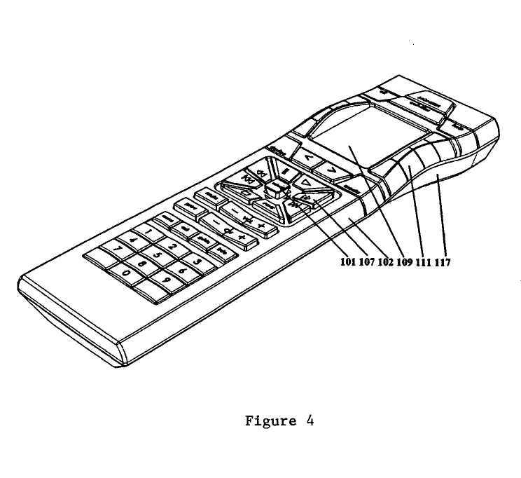

FIG. 4 is a perspective view of the remote control device incorporating joystick select button. In this view, joystick button 101 can be seen in conjunction with stadium keypad 107 encased by housing 102 which also frames display 109. To facilitate user ergonomics, housing 102 is contoured on the sides with upper hand contour 111 and lower hand contour 117.

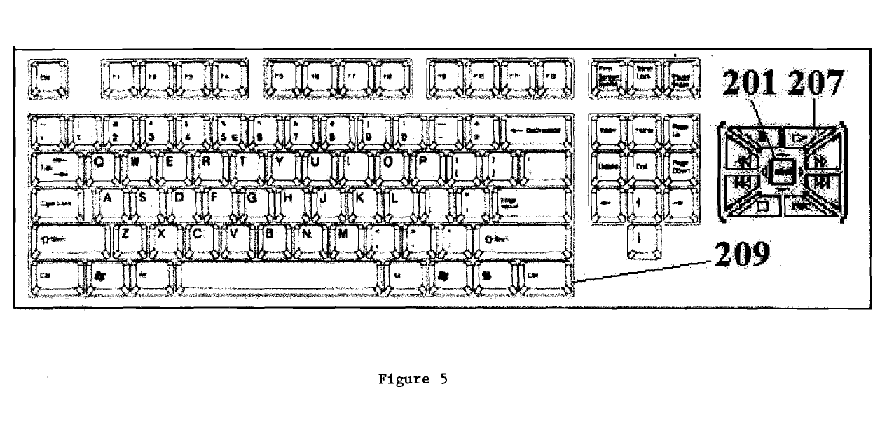

FIG. 5 is a front view of the computer keyboard device 209 incorporating joystick select button 201 and keypad stadium 207.

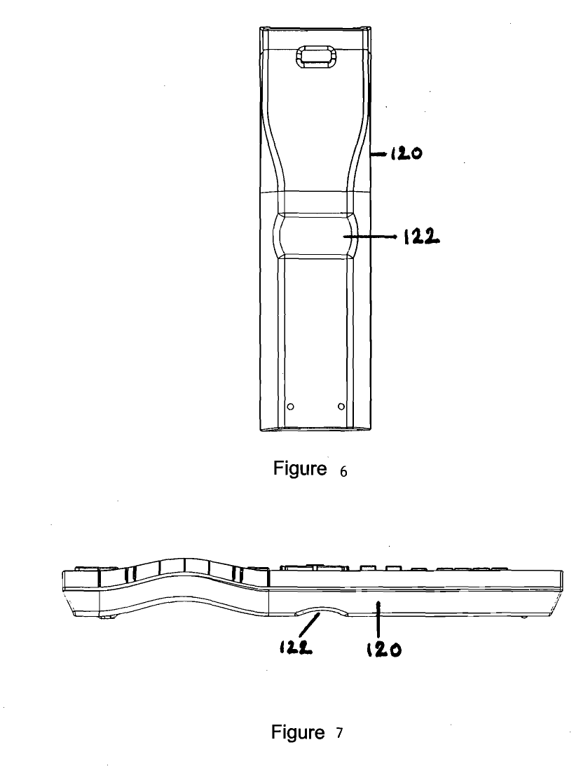

FIGS. 6 and 7 illustrate a back view and left view of the remote control device illustrating an additional embodiment of the housing 120. Housing 120 is depicted as having the same functionality as housing 102, see FIG. 1, along with containing a second indentation 122 for a finger of the user to further increase user comfort and device ergonomics.

### INDUSTRIAL APPLICABILITY

The present invention applies industrially to consumer electronics, particularly to the control of consumer electronics devices. More particularly, the present invention applies industrially to consumer electronics universal remote control devices and computer keyboards.

What is claimed is:

1. A joystick selector button device for use with consumer electronics remote control devices comprising:
a housing for electronic circuitry to control said joystick selector button;
electronic circuitry to control said joystick selector button; and
at least one joystick selector button attached to said housing and said circuitry.

2. A joystick selector button for use with consumer electronics devices as in claim 1, wherein said joystick selector button returns position information when being bent in the direction of the housing surface plane.

3. A joystick selector button for use with consumer electronics devices as in claim 1, additionally comprising an on/off pressure switch activated by downwardly directed force upon said joystick selector button.

4. A remote control physical interface for use with consumer electronics devices comprising:
a housing for electronic circuitry to control said joystick selector button;
electronic circuitry to control said joystick selector button;
at least one joystick selector button; and
a plurality of keys surrounding said joystick selector button in a ‘keypad stadium’ configuration attached to said housing and said circuitry.

5. A remote control physical interface for use with consumer electronics devices as in claim 4, wherein said plurality of keys surrounding said joystick selector button in a ‘keypad stadium’ configuration additionally comprise Braille characters corresponding to functions attributed to said keys.

6. A remote control physical interface for use with consumer electronics devices as in claim 4, wherein said plurality of keys surrounding said joystick selector button in a ‘keypad stadium’ configuration cooperatively interoperate with said joystick selector button to undertake the functionality depicted on said respective keypad stadium key with a single joystick selector button key press when angled in the direction of the respective keypad stadium key.

7. An improved remote control interface of claim 6, wherein said plurality of keys surrounding said joystick selector button in a ‘keypad stadium’ configuration incorporate media playback control characters corresponding to functions attributed to said keys.

8. An improved remote control interface of claim 7, wherein said plurality of keys surrounding said joystick selector button in a ‘keypad stadium’ configuration and said joystick selector button are physically configured to be controlled by single thumb operation.

9. An improved remote control interface of claim 7, wherein said media playback control functions are selected from the group consisting of play, fast-forward, pause, stop and record.

10. An improved remote control interface of claim 9, wherein said joystick selector button controls one or more digital video recorder devices.

11. An improved computer keyboard physical interface, the improvement comprising:
a housing for electronic circuitry to control said joystick selector button;
electronic circuitry to control said joystick selector button; and
at least one joystick selector button.

12. An improved computer keyboard physical interface of claim 11, the improvement additionally comprising a plurality of keys surrounding said joystick selector button in a ‘keypad stadium’ configuration attached to said housing and said circuitry.

13. An improved computer keyboard physical interface of claim 12, wherein said plurality of keys surrounding said joystick selector button in a ‘keypad stadium’ configuration incorporate media playback control characters corresponding to functions attributed to said keys.

14. An improved computer keyboard physical interface of claim 13, wherein said media playback control functions are selected from the group consisting of play, fast-forward, pause, stop and record.

15. An improved computer keyboard physical interface of claim 11, wherein said plurality of keys surrounding said joystick selector button in a ‘keypad stadium’ configuration incorporate Braille characters corresponding to functions attributed to said keys.
